(19) United States
(12) Patent Application Publication
(10) Pub. No.: US 2026/0208340 A1
(43) Pub. Date: Jul. 23, 2026

(54) Salt Bridge Breaking Tool

(71) Applicant: Craig Dean Hawes, Ham Lake, MN (US)

(72) Inventor: Craig Dean Hawes, Ham Lake, MN (US)

(21) Appl. No.: 19/454,142

(22) Filed: Jan. 20, 2026

Related U.S. Application Data
(60) Provisional application No. 63/748,696, filed on Jan. 23, 2025.

(51) Int. Cl. B25D 7/00; B25G 1/10; C02F 1/42; C02F 5/00

(52) U.S. Cl. CPC B25D 7/00; B25G 1/102; C02F 1/42; C02F 5/00; C02F 2303/16

(57) ABSTRACT

A salt bridge breaking tool for breaking a salt bridge in a brine tank for a water softener is provided. The salt bridge breaking tool includes a central rod connecting a handle end with a handle and a salt engagement fork end. The salt engagement fork end includes a central prong having a central prong tip and a salt engagement prong that is connected to the central rod and includes a salt engagement prong tip. The salt engagement prong is positioned at an acute angle to the central prong and is helically oriented around the central prong. Rotation of the handle causes the salt engagement prong to rotate relative to the central prong to engage with and mechanically break up a salt bridge.

### CROSS-REFERENCE TO RELATED APPLICATIONS

The present application claims the benefit of U.S. Provisional Application No. 63/748,696, filed Jan. 23, 2025, entitled “Salt Bridge Breaking Tool”, which is hereby incorporated by reference in its entirety.

### BACKGROUND OF THE INVENTION

The present invention generally relates to a tool for use with a brine tank for a water softener system. More particularly, the present invention relates to a tool to break up a salt bridge that may occur in the brine tank.

In water softeners for residential usage, salt is a consumable ingredient used to maintain system performance. Salt is stored in a brine tank or salt tank until it is needed by the water softener for a regeneration cycle. Periodically, water is added to the brine tank to create a brine solution where salt dissolves into the water. This solution washes across the salt beads in the resin tank to remove calcium and magnesium so the water softener may effectively remove those elements from the water during normal use.

FIG. 1 illustrates a typical brine tank operation for use with a water softener. FIG. 1 shows a brine tank 105 having a cover 110, and a water inlet/outlet pipe 115 positioned in a brine well 120. The brine well 120 includes openings 125 positioned near the base of the brine tank 105. The brine well 120 also includes a float and valve assembly 130. Inside the brine tank 105 is positioned granular salt 135. The lower portion of the brine tank 105 is filled with water up to the water fill level 140. Thus, below the water fill level 140 the water mixes with the granular salt 135 to form a brine 145 in the granular salt.

In operation, as shown in FIG. 1, water enters the brine tank 105 through the water inlet/outlet pipe 115 in the brine well 120 and then emerges from the brine well 120 through the openings in the brine well 125. The addition of water causes a portion of the granular salt to dissolve to form a brine composed of highly concentrated salt. The brine forms in the brine tank 105 up to the water fill level 140.

During operation, the water softener sends water into the brine tank 105 through the water inlet/outlet pipe (which may also be referred to as a brine line) to form the brine. The brine solution may then be withdrawn from the bottom of the brine tank 105 through the openings in the brine well 125 and back through the water inlet/outlet pipe 115 to the water softener so that the water softener may use the brine to soften water. The float and valve assembly 130 controls the water level, ensuring the right amount fills the tank to dissolve salt for regeneration/water softening while acting as a safety feature to prevent overflows by shutting off incoming water if the water level gets too high. The float and valve assembly 130 also seals the brine well to prevent air from being drawn in during the brine draw cycle in order to maintaining system efficiency.

As the water/brine is removed through the water inlet/outlet pipe 115, the granular salt 135 at the bottom of the brine tank 105 erodes (or is further dissolved). During normal operation, when the granular salt 135 at the bottom of the brine tank 105 erodes (thus decreasing in total volume), gravity causes the granular salt that is positioned above the eroding salt to be downwardly displaced toward the bottom of the brine tank 105. Alternatively, when the brine tank 105 functions correctly, gravity feeds granular salt from the upper section of the tank to fill in the bottom of the tank.

FIG. 2 illustrates the brine tank of FIG. 1 experiencing an undesirable salt bridge 210 and salt mushing. A salt bridge 210 occurs when individual salt granules begin to solidify or adhere together over time within the brine tank and form a bridge-shaped solid structure spanning the interior diameter of the brine tank 105. Additional salt that is positioned over the salt bridge 210 is then blocked or unable to pass through the salt bridge 210 to the brine 145. Because the granular salt 135 positioned over the salt bridge 210 is unable to enter the brine 145, the brine is often not able to achieve the desired salinity for proper operation of the water softener, which impairs the functionality of the water softener.

As shown in FIG. 2, the salt bridge 210 is typically formed above the bottom of the brine tank so that a water or air gap is created between the tank bottom and the salt bridge. Additional granular salt may also reside above the salt bridge, but it is unable to feed down to the bottom of the tank due to the solidified salt mass of the salt bridge. Subsequently, the continued salt erosion occurs at the bottom of the tank and hollows out a void without salt (or with a reduced salt volume) near the openings in the brine well.

Due to the void at the bottom of the tank, the water in the tank does not dissolve salt at the desired rate. Then, the salt/water mixture does not meet the expected salt concentration and water softener performance is reduced.

Typically, the salt bridge grows over time and does not typically self-heal in the brine tank. For example, the salt bridge may become thicker over time as additional humidity from the water in the brine tank 105 impacts a greater thickness of granular salt 135 causing a greater vertical thickness of granular salt to adhere to form a thicker salt bridge 210.

Additionally, because the granular salt 135 positioned on top of the salt bridge 210 prevents visual observation of the salt bridge 210, there may not be a clear warning that the salt bridge has occurred. An observant user may notice that the water softener stops consuming salt or that water no longer feels soft. However, they will not be able to directly observe the presence of a salt bridge because the salt bridge is underneath the top layer of salt in the brine tank. This may prevent a user from being able to determine why the performance of a water softener has declined.

When the user suspects the presence of a salt bridge, the user may seek to break up or destroy the salt bridge. In one example, a user may insert a stick or broom handle deep into the granular salt 135 of the brine tank 105 in an effort to break up the suspected salt bridge. However, removing the salt bridge may be an uncertain, difficult, and labor-intensive activity. For example, the stick may be difficult to push into or through the salt, especially if there is granular salt above the salt bridge. For example, the granular salt may be heavy and difficult to displace and may also induce friction on the stick attempting to pass through the salt that may impede the motion of the stick. Although the granular salt above the salt bridge may be removed, such a process is messy and time consuming and thus not typically performed by a user.

Further, even if the user is able to induce the sick through the granular salt 135 to make contact with the top surface of the salt bridge 210, the user must then be able to induce sufficient force through the stick into the salt bridge 210 to cause the salt bridge to break, which may be difficult due to the displacement-resisting weight and friction caused by the granular salt.

Additionally, even if the user is able to penetrate the salt bridge with the blunt stick, minimal destruction of the salt bridge occurs. Only a small hole similar to the size of the stick is created through the salt bridge, and many holes are required to compromise the structure of the salt bridge. Relatively little salt may make its way through any single small hole and the performance of the system may not be improved.

Additionally, because the salt bridge is underneath the top layer of salt, the user is unable to directly observe the status of the salt bridge and whether it is still in place or has been destroyed. Even multiple insertions of the stick may not destroy the salt bridge.

To maintain proper function of the water softener, the salt level in the brine tank should adhere to the manufacturer's recommendation. The user must also determine that salt in the brine tank is dissolving into the brine at the expected rate. A salt bridge is one common cause that prevents the proper mixing of salt and water into the brine solution.

FIG. 2 also shows undesirable salt mushing 220 at the bottom of the brine tank 105. In operation, the granular salt 135 may include impurities that are not water-soluble. These impurities may accumulate at the bottom of the brine tank 105 through successive iterations of water being injected into the brine tank 105 through the water inlet-outlet pipe 115 causing granular salt 135 to dissolve into a brine, and then the brine being removed from the brine tank 105 through openings in the brine well 125 to pass out of the brine tank 105 the water-inlet-outlet pipe 115. A salt mush 220 composed of the undissolved impurities is then formed at the bottom of the brine tank 105. The salt mush 220 may be sludge-like, semi-solid, or solid. The salt mush 220 may clog and inhibit proper filling and draining of the brine tank 105 by blocking the openings in the brine well 125 or blocking the end of the water inlet/outlet pipe 115. Thus, the water softener may not be able to function correctly while the salt mush 220 is in place. However, removing the salt mush 220 may be difficult because the salt mush may be semi-solidified, dense, and may tend to cling together.

### BRIEF SUMMARY OF THE INVENTION

One or more embodiments of the present invention provide a salt bridge breaking tool for breaking a salt bridge in a brine tank for a water softener. The salt bridge breaking tool includes a handle at a handle end that is connected to a salt engagement fork end by a central rod. The salt engagement fork end includes a central prong having a central prong tip and a salt engagement prong that is connected to the central rod and includes a salt engagement prong tip. The salt engagement prong is positioned at an acute angle to the central prong and is helically oriented around the central prong. Rotation of the handle causes the salt engagement prong to rotate relative to the central prong to engage with and mechanically break up a salt bridge.

### BRIEF DESCRIPTION OF THE DRAWINGS

FIG. 1 illustrates a typical brine tank operation for use with a water softener.

FIG. 2 illustrates a brine tank experiencing an undesirable salt bridge and salt mushing.

FIG. 3 illustrates a top view of a salt bridge breaking tool according to an embodiment of the present invention.

FIG. 4 illustrates a side view of the salt bridge breaking tool of FIG. 3 according to an embodiment of the present invention.

FIG. 5 illustrates an end view of the salt bridge breaking tool of FIG. 3 according to an embodiment of the present invention.

FIG. 6 illustrates a close up view of the salt engagement fork end of the salt bridge breaking tool of FIG. 3.

FIG. 7 shows a close up end view of the salt bridge breaking tool of FIG. 3.

FIG. 8 illustrates a top view of the alternative embodiment of the salt engagement fork end according to an embodiment of the present invention.

FIG. 9 illustrates a side view of the alternative embodiment of the salt engagement fork end according to an embodiment of the present invention.

FIG. 10 illustrates an end view of the alternative embodiment of the salt engagement fork end according to an embodiment of the present invention.

FIG. 11 is similar to FIG. 6 and shows a close up view of the salt engagement fork end of the salt bridge breaking tool of FIGS. 8-10.

FIG. 12 is similar to FIG. 7 and shows a close up end view of the salt bridge breaking tool of FIGS. 8-10.

FIG. 13 shows a perspective view of the depth marker and/or limiter positioned on a central rod of the salt bridge breaking tool.

FIG. 14 shows a top view of the depth marker and/or limiter.

FIG. 15 shows a side view of the depth marker and/or limiter.

FIG. 16 illustrates a first alternative handle including a first handle arm and a second handle arm, a handle top, and a central rod similar to those shown in FIG. 3.

FIG. 17 illustrates a second alternative handle including a first handle arm and a second handle arm, a handle top, and a central rod similar to those shown in FIG. 3.

FIG. 18 illustrates a third alternative handle including a first handle arm and a second handle arm, a handle top, and a central rod similar to those shown in FIG. 3.

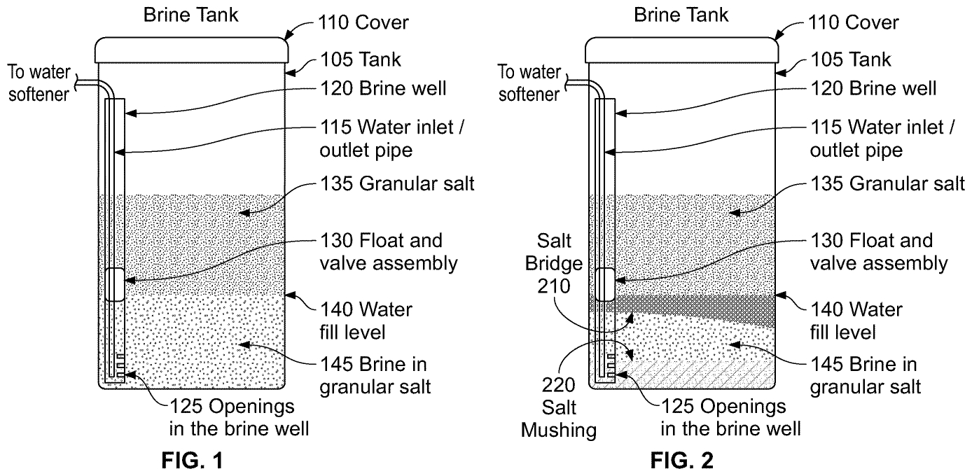

### DETAILED DESCRIPTION OF THE INVENTION

One or more embodiments of the present invention provide a salt bridge breaking tool having a number of useful features including: 1) a central rod terminating in a small diameter, low friction central prong for easy insertion into a salt bridge, 2) a handle having grip locations generally parallel to the central rod and separated by a lever distance so that a user engaging the grip locations may rotate the grip locations to cause the central rod to rotate, 3) a helical salt engagement prong positioned in a helical fashion relative to the central rod so that rotation of the central rod causes the helical salt engagement prong to be driven further into a salt bridge, 4) the helical salt engagement prong includes a terminal structure that is curved inward toward the central rod so that contact of the helical salt engagement prong with the side or bottom of a salt tank will not damage the tank, and 5) the vertical extent of the helical salt engagement prong along the central rod is less than the central rod itself so that the central rod does not experience additional resistance when initially contacting a salt bridge that it otherwise would if the helical salt engagement prong was coextensive with the central rod.

As further described below, when either a salt bridge or a solidified area of salt mushing forms in a brine tank, they must be broken apart to restore function of the brine tank. One or more of the embodiments of the present invention may be used to either break apart salt formations such as a salt bridge so that water may regain contact with granular salt or to remove undissolved material from the brine tank. One or more of the embodiments of the present invention may be held by the handle end and used to pierce into the solidified salt formation. Tactile feedback through the handle end allows the user to determine if there are hard spots or voids hidden below the surface of the granular salt.

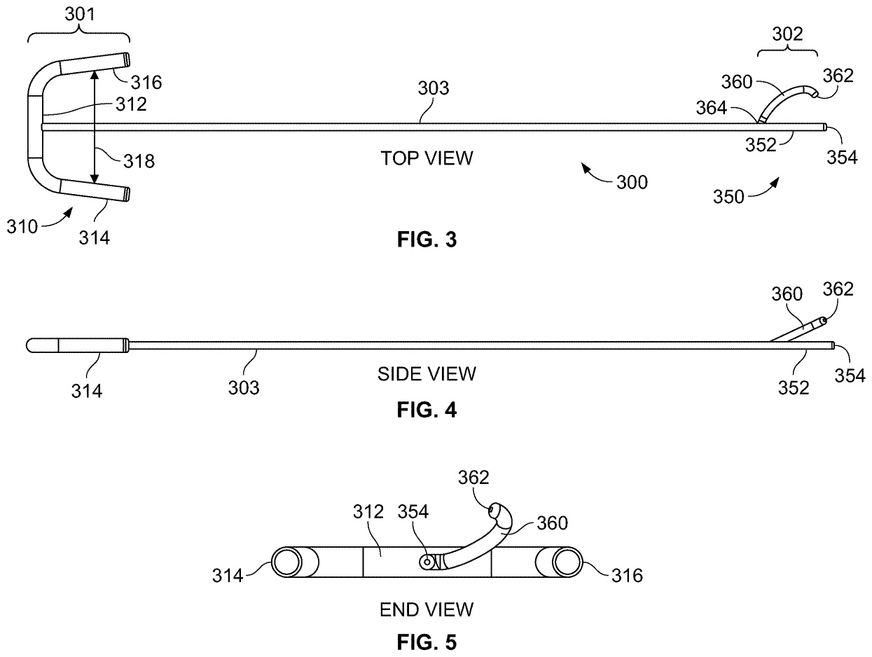

FIG. 3 illustrates a top view of a salt bridge breaking tool 300 according to an embodiment of the present invention. As shown in FIG. 3, the salt bridge breaking tool 300 includes a handle end 301 and a salt engagement fork end 302 that are connected by a central rod 303. The handle end 301 includes a handle 310 having a handle top 312, a first handle arm 314 and a second handle arm 316. The salt engagement fork end 302 includes a salt engagement fork 350 including a first, central prong 352 having a central prong tip 354, and a helical salt engagement prong 360 having a salt engagement prong tip 362. The salt engagement prong 360 is attached to the central rod 303 at a prong attachment junction 364.

FIG. 4 illustrates a side view of the salt bridge breaking tool 300 of FIG. 3 according to an embodiment of the present invention. FIG. 4 shows the first handle arm 314, central rod 303, central prong 352, and salt engagement prong 360.

FIG. 5 illustrates an end view of the salt bridge breaking tool 300 of FIG. 3 according to an embodiment of the present invention. FIG. 5 shows the first handle arm 314, second handle arm 316, central prong top 354, salt engagement prong 360 and salt engagement prong tip 362.

In operation, once the salt bridge breaking tool 300 is inserted into the salt and comes in contact with a salt bridge, a user grasps the first handle arm 314 and second handle arm 316 and induces them to rotate in opposite directions. The rotational motion of the handle arms 314, 316 translates into rotational motion of the rod 303 which causes the salt engagement prong 350 to rotate around the central prong 352. The rotation of the salt engagement prong 350 to around the central prong 352 drives the tool deeper into the salt bridge and breaks up a large area of the salt bridge. To put it another way, rotation of the salt bridge breaking tool 300 breaks apart solidified salt and aids in driving the tool deeper into granular salt.

When breaking apart solidified salt, the central prong tip 354 engages with the salt first and serves to help stabilize the tool 300. Then as the tool 300 is rotated, the helical salt engagement prong 360 may act on the salt which it contacts.

The handle 310 at the handle end 301 of the tool 300 may be operated in a first mode using a single hand or a second mode using two hands. In the first mode, the user's primary hand is positioned on the handle top 312, for example with the user's palm pressing downwardly to exert a force in line with the rod 303. The user may then place their other hand on one of the handle arms 314, 316 and move the tool up and down vertically, move the handle laterally, and rotate the tool. Additionally, the handle top 312 may be used as a percussion zone where a hand or other blunt object may apply a hammering motion or impact to assist in driving the tool 300 into the salt. Of the two mode of operation, this mode may allow a user to provide more vertical downward force into the salt bridge.

In a second mode of operation, the user grasps the first handle arm 314 with a first hand and grasps the second handle arm 316 with their second hand. As shown in FIG. 3, the first handle arm 314 and second handle arm 316 are separated by a separation distance 318. Because the user grips the handle arms 314, 316 with opposing hands and the handle arms 314, 316 are separated by the separation distance 318, the user is able to apply significant leverage to twist or rotate the tool 300.

In one embodiment, the separation distance 318 is 160 mm. Alternatively, the separation distance may be in the range of 50 mm to 400 mm, with a greater separation distance allowing a user to apply greater leverage to rotate the tool 300.

In one embodiment, the handle 310 includes a padding or grip material covering at least one or more of the handle arms 314,316. The padding or grip material may increase the friction between the user's hand and the handle arm 314, 316 to allow the user to better hold the handle arm and thus to further aid in controlling the tool 300.

In one embodiment, one or more of the handle arms 314, 316 are tapered away or angled away from the central rod 303. This taper may be an acute angle such as 7 degrees, for example. Tapering the handle arms 314, 316 may provide a more ergonomic grip position and a grasping surface that may more easily be used to exert downward pressure on the tool. For example, the grip position may be more ergonomic because the user may grasp both handle arms 314, 316 in a hammer-type grip while forcing the tool 300 downward into the salt. Alternatively, the handle arms 314, 316 may be positioned at an angle in a range from zero (parallel to the central rod 303) to up to 60 degrees angled away from the central rod.

Alternative embodiments of the handle 310 of FIG. 3 are shown in FIGS. 16-18.

FIG. 16 illustrates a first alternative handle 1600 including a first handle arm 1614 and a second handle arm 1616, a handle top 1612, and a central rod 1603 similar to those shown in FIG. 3. However, the embodiment of FIG. 16 includes a top grip structure 1620 that is attached to the handle top 1612. The top grip structure 1620 include a first support 1622, a second support 1624 and a top grip location 1626. The first and second supports 1622, 1624 join the top grip location 1626 with the handle top 1612. Additionally, the handle arms 1614, 1616 now include handle end caps 1630 and widened grip structures 1640.

As shown in FIG. 16, the top grip location 1626 is mechanically connected to the central rod 1603 such that the central rod 1603 would not be positioned between the fingers of a hand of a user grasping the handle top 1612, as would happen in the embodiment of FIG. 3. That is, when the user grasps the top grip location 1626, the user's hand may wrap firmly around the top grip location 1626 without being impaired by the presence of the central rod 1603.

In one embodiment, the distance between the first support 1622 and second support 1624 is 120 mm. Alternatively, this distance may be in the range of 70 mm to 200 mm. Additionally, the distance between the top grip location 1626 and the handle top may be 40 mm, but may alternatively be in the range of 30 mm-100 mm.

As shown in FIG. 16, the first handle arm 1614 and second handle arm 1616 are connected to the handle top 1612 at a first, proximal end. At the opposite, distal ends of the handle arms 1614, 1616 is positioned an end cap 1630. Additionally, the handle arms 1614, 1616 include widened grip structures 1640 disposed between the proximal and distal ends. Both the end caps 1630 and widened grip structures 1640 may serve to give the user tactical feedback while the tool is in use and reduce the likelihood of the user's hand sliding off of a handle arm. Additionally, the end caps 1630 and widened grip structures 1640 may be used to resist downward force when operating the tool. Additionally, the widened grip structures 1640 may be curved as shown in FIG. 16, for example to improve the ergonomics of gripping the handles. Alternatively, the widened grip structures 1640 may be cylindrical.

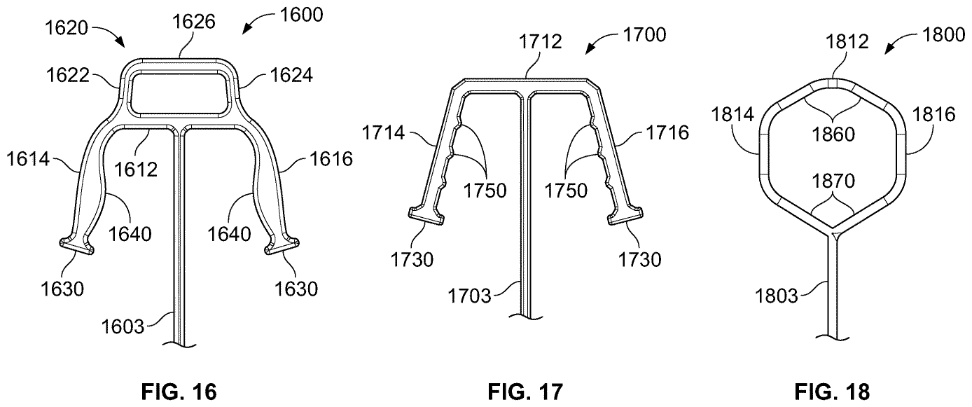

FIG. 17 illustrates a second alternative handle 1700 including a first handle arm 1714 and a second handle arm 1716, a handle top 1712, and a central rod 1703 similar to those shown in FIG. 3. However, the handle arms 1714, 1716 now include handle end caps 1730 and a plurality of contoured grip protrusions 1750. As shown in FIG. 17, the first handle arm 1714 and second handle arm 1716 are connected to the handle top 1712 at a first, proximal end. At the opposite, distal ends of the handle arms 1714, 1716 is positioned an end cap 1730. Additionally, the handle arms 1714, 1716 include contoured grip protrusions 1750 disposed between the proximal and distal ends. Both the end caps 1730 and widened grip structures 1740 may serve to give the user tactical feedback while the tool is in use and reduce the likelihood of the user's hand sliding off of a handle arm. Additionally, the end caps 1730 and widened grip structures 1740 may be used to resist downward force when operating the tool.

FIG. 18 illustrates a third alternative handle 1800 including a first handle arm 1814 and a second handle arm 1816, a handle top 1812, and a central rod 1803 similar to those shown in FIG. 3. However, the handle 1800 is a circular or ovoid configuration so that the handle arms 1814, 1816 are connected to the handle top 1812 by curved or angled handle-top transition structures 1860 and the handle arms 1814, 1816 are connected to the central rod 1803 by curved or angled handle-rod transition structures 1870.

In operation, the curved or angled handle-rod transition structures 1870 may operate similarly to the end caps 1630 of FIG. 16 to give the user tactical feedback while the tool is in use and reduce the likelihood of the user's hand sliding off of a handle arm, as well as to resist downward force when operating the tool.

In an alternative embodiment of the handle, any of the features shown in FIGS. 16-18 may be combined.

Returning now to the salt bridge breaking tool 300 of FIGS. 3-5, as discussed above, at the salt engagement fork end 302 is shown a fork composed of two prongs, the first, central prong 352 and the helical salt engagement prong 360. The prongs may be used for engaging salt to break apart salt bridges and salt mushing. The central prong 352 aligns with the axis of the rod 303. The second helical salt engagement prong 360 extends away from the rod and wraps around the rod. These prongs work together to give the user increased leverage to penetrate granular salt and improved ability to break apart solidified salt with movements of the handle as compared to a broom handle or straight stick. This tool creates leverage that amplifies input forces to minimize the difficulty of driving the fork end 302 into salt and applies mechanical action to a salt bridge. Once the fork is contacting the salt bridge, the distance between the central prong 352 and salt engagement prong 360 maximizes the area or volume of an effective zone where salt may be separated from the solidified salt by mechanical interaction with one or both of the prongs. This increased effective diameter of the fork as compared to a broom handle or stick reduces the number of times that the salt bridge needs to be engaged to be broken apart. This saves time and effort for the user.

The salt bridge breaking tool 300 also differs in design from other mixing tools as this tool is designed specifically to be effective in breaking apart solidified salt. For example, the ends of the prongs are not connected by a direct member because an increased cross-sectional area of the salt engagement fork would reduce the tool's effective penetration depth into the salt. The end of the central prong 352 being smaller than a broom handle gives another advantage that makes this tool easier to push into the salt because the central prong 352 only needs to displace a smaller volume of salt and experiences less friction with the salt.

The central prong tip 354 extends further down vertically than the salt engagement prong tip 362 which allows the central prong tip 354 to engage the salt and stabilize the tool by establishing a point of rotation for the tool. The end of the central prong tip 354 is rounded or chamfered to reduce drag when pushing into the salt. Also, the rounded surface reduces the likelihood of damaging the brine tank if the tool contacts the brine tank.

The helical salt engagement prong 360 extends outward from the prong attachment junction 364 with the central rod 303 and is positioned at an angle to the rod to follow a trajectory similar to a screw thread when rotated. In one embodiment, the helical salt engagement prong 360 is positioned at an acute angle of 20 degrees relative to the central prong 352, but may alternatively be positioned in the range of 10-60 degrees relative to the central prong 352. The primary embodiment follows a right-hand thread. The right-hand thread allows for intuitive operation of the tool when screwing it into salt. In an alternative embodiment a left-hand thread may be used with similar mechanical results.

The helical salt engagement prong 360 wraps cylindrically around the central rod 303 by at least 15 degrees, but may include an angular progression anywhere from 15-270 degrees around the central rod 303. The progression of the helical salt engagement prong 360 around the main rod 303 enhances the functionality of the tool. For example, the curve of the salt engagement prong 360 allows the salt engagement prong tip 362 to be directly introduced into the salt bridge as the tool is rotated. As opposed to a non-curved prong that may simply extend outward from the central rod 303, the smaller contact surface area of the salt engagement prong tip 362 (as opposed to the entire length of the side of a flat prong) allows the salt bridge to be more easily pierced and destroyed.

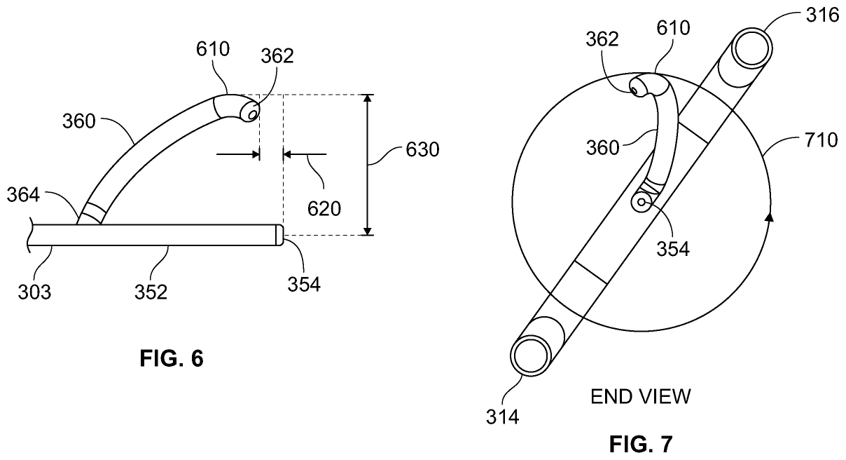

FIG. 6 illustrates a close up view of the salt engagement fork end of the salt bridge breaking tool of FIG. 3. FIG. 6 shows the central rod 303, central prong 352 having a central prong tip 354, helical salt engagement prong 360 having a salt engagement prong tip 362, and the prong attachment junction 364. Also shown is the maximum axial extent 610 of the salt engagement prong 360.

As shown in FIG. 6, the lowest, terminal end of the central prong tip 354 extends further down the axial direction of the central rod 303 than the lowest, terminal end of the salt engagement prong tip 362 by a vertical offset distance 620. Additionally, the maximum axial extent 610 of the salt engagement prong 360 from the central rod 303 is shown by the axial offset distance 630.

In one embodiment, the vertical offset distance 620 is 10 mm. Alternatively, this distance may be in the range of 5 mm to 150 mm.

In one embodiment, the axial offset distance 630 is 60 mm from the axis of the central rod 303 to the outer edge of the curvature of the helical salt engagement prong 360. Alternatively, this distance may be in the range of 15 mm to 150 mm.

Due to the rotational, axial, and and/or transverse leverage provided by a user between the handle arms 314, 316 that is translated to the salt engagement fork end 302, large forces may be achieved at the central prong tip 354 and/or salt engagement prong tip 362. Therefore, the tool 300 includes features to reduce likelihood of the tool damaging the brine tank. First, the helical salt engagement prong 360 has its salt engagement prong tip 362 offset above the end of the central prong tip 354 by the vertical offset distance 620. This offset is designed such that if the tool contacts the bottom of the brine tank, the central prong tip 354 will rotate on the bottom of the tank rather than the central prong tip 354 and salt engagement prong tip 362 horizontally translating or moving across the bottom of the tank. This will reduce risk of tank damage. Alternative embodiments may include a vertical offset distance 620 of less than 5 mm or a reversed offset where the salt engagement prong tip 362 extends beyond the central prong tip 354.

FIG. 7 shows a close up end view of the salt bridge breaking tool 300 of FIG. 3. FIG. 7 shows the first handle arm 314, second handle arm 316, central prong tip 354, a helical salt engagement prong 360, maximum axial extent 610, and salt engagement prong tip 362. FIG. 7 also shows an area of mechanical interaction 710 between the salt bridge breaking tool 300 and the surrounding materials during operation. More specifically, as the salt bridge breaking tool 300 is rotated by a user using the handle arms 314, 316, the central prong tip 354 is preferably mechanically engaged with salt, a salt bridge, or the bottom of the brine tank and the helical salt engagement prong 360 and salt engagement prong tip 362 rotate around the central rod 303 in an area described be the area of mechanical interaction 710. This may also be referred to as the radius of curvature.

As shown in both FIGS. 6 and 7, the end of the helical salt engagement prong 360 includes a salt engagement prong tip 362 that is not parallel to the center rod 303. Instead, the salt engagement prong tip 362 is oriented at an angle that curves back toward the center rod 303. In the event that the helical salt engagement prong 360 contacts a tank side or a feature within the brine tank, the contact will be with the side of the helical salt engagement 360 prong rather than the small diameter end of the salt engagement prong tip 362. The fact that the terminal structure of the helical salt engagement prong 360 curves back toward the central rod will reduce forces on a contacted tank structure and reduce potential for tank damage. The maximum axial extent 610 of the salt engagement prong 360 will slide along a surface more easily than would the end of the salt engagement prong tip 362 that may potentially press upon and may more easily damage internal surfaces of a brine tank.

The motion of the handle end 301 combined with the helical salt engagement prong 360 allows for deeper driving of the tool 300 into the salt than a stick. The salt engagement fork end 302 both breaks apart the hardened salt and provides downward force into the salt. As the user encounters increased resistance by inserting the salt engagement fork end 302 deeper into the salt, the handle may be moved in ways that help to overcome the resistance.

During a first method of using the tool 300 it may be pushed straight down from the handle end. In some cases, this will be enough to break apart solidified salt.

In a second method of use, the entire tool 300 may be rotated about the axis of the central rod 303. As mentioned above, the handle end 301 includes two handle arms 314, 316 that are positioned generally parallel to the main shaft. When the user applies each hand to one of the handle arms 314, 316, the user may apply opposite forces on the handle arms 314, 316 which will rotate the tool 300 and allow it to pull itself deeper into the salt. Rotating the helical salt engagement prong 360, will produce a vertical force due to its inclined geometry. Stated another way, as the tool 300 is rotated, the helical orientation of the helical salt engagement prong 360 causes salt to be displaced vertically upward on top of the helical salt engagement prong 360, which produces a further downward force on the helical salt engagement prong 360. Additionally, when the helical salt engagement prong 360 is rotated while inserted into a self-adhering layer of salt, the cohesive strength of the self-adhering salt presses upon the upper edge of the helical salt engagement prong 360 to translate the rotational force into a downward vertical force.

In an alternate method of using the tool 300, the handle end 301 may be moved or rotated in a circular motion perpendicular to the axis of the central rod 303 that allows the helical salt engagement member to intermittently contact solidified salt and due to the helical salt engagement member's angle, the tool is driven further down.

Once the salt engagement fork end 302 is driven through granular salt to the depth of the salt bridge, the user will receive tactile feedback through the handle arms 314, 316 that the salt has higher resistance. As the fork end breaks through the bottom of a salt bridge into a gap, the user will easily feel the decrease in resistance. This allows a user to successfully determine when the salt bridge has been eliminated, even when the user may not see the salt bridge under a layer of salt.

Once solidified salt is loosened, the tool 300 may be removed from the salt and moved to a new location in the brine tank to repeat the process. Once all salt has been loosened as desired, the brine tank may be left to its normal function, or the salt may be more easily removed from the tank now that it is no longer a solidified salt mass.

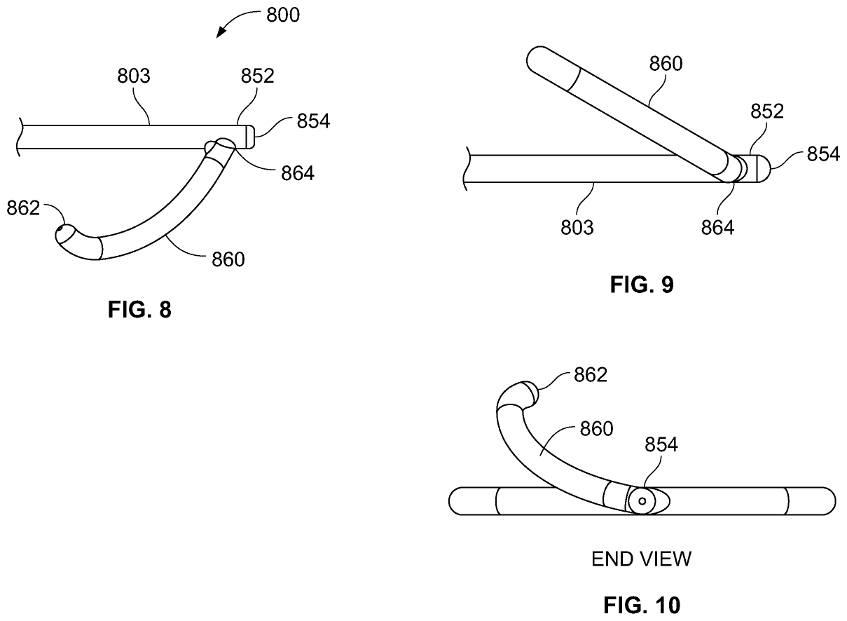

FIGS. 8-10 illustrate an alternative embodiment 800 of the salt engagement fork end according to an embodiment of the present invention. FIG. 8 illustrates a top view of the alternative embodiment 800 of the salt engagement fork end according to an embodiment of the present invention. FIG. 8 shows a central rod 803 and a first, central prong 852 having a central prong tip 854, and a helical salt engagement prong 860 having a salt engagement prong tip 862. The salt engagement prong 860 is attached to the central rod 803 at a prong attachment junction 864.

FIG. 9 illustrates a side view of the alternative embodiment 800 of the salt engagement fork end according to an embodiment of the present invention. FIG. 9 shows the central rod 803 the first, central prong 852 having the central prong tip 854, the helical salt engagement prong 860 and the prong attachment junction 864.

FIG. 10 illustrates an end view of the alternative embodiment 800 of the salt engagement fork end according to an embodiment of the present invention. FIG. 10 shows the central prong tip 854, the helical salt engagement prong 860 and the salt engagement prong tip 862.

In the embodiment of FIG. 3, the prong attachment junction 364 is positioned well-away from the central prong tip 354 so that the helical salt engagement prong 360 is oriented downwardly towards the central prong tip 354. Conversely, in the embodiment of FIG. 8-10, the prong attachment junction 864 is positioned near to the central prong tip 854 so that the helical salt engagement prong 860 is oriented upwardly away from the central prong tip 854 and toward the handle end.

In one embodiment, the distance between prong attachment junction 864 and the central prong tip 854 is 15 mm. Alternatively, it may be in a range of 0 mm to 100 mm.

The helical salt engagement prong 860 of FIGS. 8-10 is generally similar to the helical salt engagement prong 360, just oriented in reverse.

FIG. 11 is similar to FIG. 6 and shows a close up view of the salt engagement fork end of the salt bridge breaking tool of FIGS. 8-10. FIG. 11 shows the central rod 803, central prong 852 having a central prong tip 854, helical salt engagement prong 860 having a salt engagement prong tip 862, and the prong attachment junction 864. Also shown is the maximum axial extent 1110 of the salt engagement prong 860.

As shown in FIG. 11, the lowest, terminal end of the central prong tip 854 extends further down the axial direction of the central rod 803 than the prong attachment junction 864 by a vertical offset distance 1120.

In one embodiment, the vertical offset distance 1120 is 15 mm. Alternatively, this distance may be in the range of 0 mm to 100 mm.

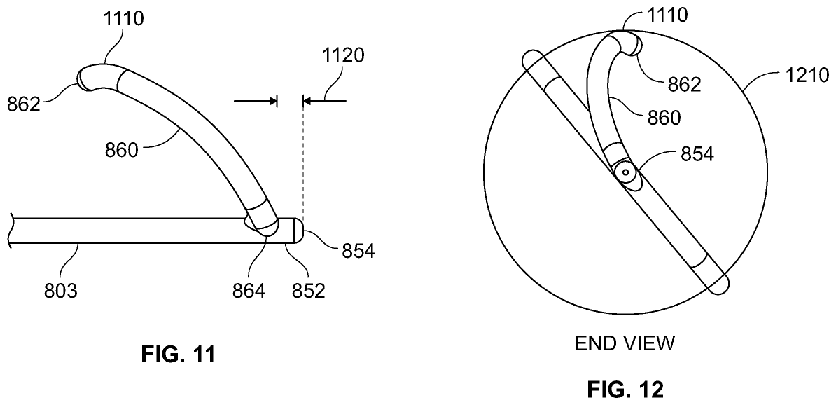

FIG. 12 is similar to FIG. 7 and shows a close up end view of the salt bridge breaking tool 800 of FIGS. 8-10. FIG. 12 shows the, central prong tip 854, the helical salt engagement prong 860, the maximum axial extent 1110, and the salt engagement prong tip 862. FIG. 12 also shows an area of mechanical interaction 1210 between the salt bridge breaking tool 800 and the surrounding materials during operation. More specifically, as also described in FIG. 7, as the salt bridge breaking tool 800 is rotated by a user using the handle arms the central prong tip 854 is preferably mechanically engaged with salt, a salt bridge, or the bottom of the brine tank and the helical salt engagement prong 860 and salt engagement prong tip 862 rotate around the central rod 803 in an area described be the area of mechanical interaction 1210. This may also be referred to as the radius of curvature.

In one embodiment, the central rod 303, helical salt engagement prong 360, and/or handle end 301 may be composed of stainless steel. Stainless steel is corrosion resistant to a salty environment and has favorable characteristics for manufacturing of the tool. It is strong enough to resist torsion and bending loads generated by the usage of the tool.

In an alternative embodiment one or more components of the tool 300 is composed of a steel core with a molded a plastic material over the core. The steel core provides the strength to resist torsion and bending loads generated by the usage of the tool. The plastic outer layer may serve as a corrosion shield for the steel from the salty environment of a brine tank. Hand grips and depth markings may be included in the molded plastic.

In one or more embodiments, the central rod 303 may be round and have a diameter of 10 mm. Alternatively, the diameter may between 6 mm and 16 mm. In an alternative embodiment, the central rod 303 shape may be a square or a rectangle. Each side of rectangular shape may be between 6 mm and 25 mm. The corners of the profile may be rounded. The overall length of the tool from the top of the handle 7 to the tip of the salt engagement prong may be 1065 mm. Alternatively, the tool may be 200 mm to 1800 mm in length.

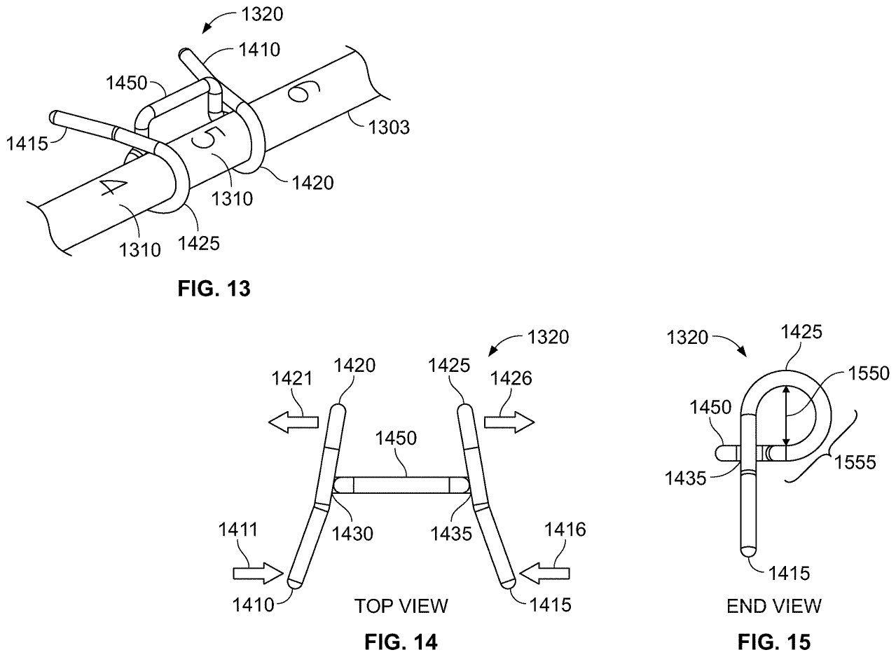

FIG. 13-15 illustrate a depth marker and limiter according to one embodiment of the present invention.

FIG. 13 shows a perspective view of the depth marker and/or limiter positioned on a central rod of the salt bridge breaking tool. FIG. 13 illustrates a central rod 1303 of the salt bridge breaking tool. Along the length of the central rod 1303, depth markings 1310 are positioned. The depth markings 1310 preferably start at the central prong tip of the central prong and extend up the central rod 1303 to the handle end. The depth markings 1310 may be used to allow the user to know the depth of the central prong tip when it is inserted into the brine tank. The depth markings 1310 may take the form of engravings, notches, or coatings.

Additionally, an adjustable depth marker and/or limiter 1320 may be included or positioned on the central rod 303 to allow the user to measure and/or set a safe depth for the tool operation. For example, the user may set the adjustable depth marker and/or limiter 1320 at a current height of salt in the brine tank, then allow the water softening system to function normally for several days, and then re-insert the tool into the salt to compare the new height of salt with the previously marked height of salt in order to measure the salt consumption between measurements. Additionally, the adjustable depth marker and/or limiter 1320 may cause the downward motion of the tool into the salt to be stopped or limited when the salt comes into contact with the lower arm of the adjustable depth marker and/or limiter 1320.

The depth limiter 1320 may be free to travel along central rod 303 between the prong attachment junction and the bottom of the handle end as shown in FIG. 3. When a user moves the depth limiter (as described below), the depth limiter 1320 stays in place on the central rod 303 in normal use. In one embodiment, the prong attachment junction is located a known distance from the end of the central prong tip 354 and the depth limiter may be displaced along the central rod 1303 down to the prong attachment junction. In one embodiment this distance is 90 mm. Alternatively, this distance may range from 25 mm to 150 mm.

FIG. 14 shows a top view of the depth marker and/or limiter 1320. FIG. 14 shows a first user engagement arm 1410, a second user engagement arm 1415, a first central rod engagement loop 1420, a second central rod engagement loop 1425, a first engagement arm pivot location 1430, a second engagement arm pivot location 1435, and a crosspiece 1450. In one embodiment, the depth marker and/or limiter 1320 is composed of a spring material such as steel.

In operation, a user exerts an inward force on both the first user engagement arm 1410 and second user engagement arm 1415 as shown in FIG. 14 by user force arrows 1411, 1416. The force provided by the user causes the user engagement arms 1410, 1415 to be displaced inwardly, which in turn causes the first and second central rod engagement loops 1420, 1425 to pivot about the first and second engagement arm pivot locations 1430, 1435 outwardly in the direction shown by the central rod engagement loop displacement arrows 1421, 1426 shown in FIG. 14.

When the depth marker and/or limiter 1320 is in the unactuated position as shown in FIG. 14 before the user applies force to the engagement arms 1410, 1415, the engagement loops 1420, 1425 are not perpendicular to the axis of the central rod 1303. The engagement loops 1420, 1425 are sized so that when the engagement loops 1420, 1425 are not perpendicular to the central rod 1303, one or more surfaces of the engagement loops 1420, 1425 contacts the central rod 1303 and is held in contact with the central rod 1303 by the spring force exerted by the depth marker and/or limiter 1320 and/or friction between the central rod 1303 and the depth marker and/or limiter 1320. Conversely, when the user applies force to the engagement arms 1410, 1415, the engagement loops 1420, 1425 to pivot about the first and second engagement arm pivot locations 1430, 1435 so that the engagement loops 1420, 1425 become more perpendicular to the central rod 1303. The engagement loops 1420, 1425 are sized so that when they become more perpendicular with the central rod 1303, the depth marker and/or limiter 1320 either no longer contacts the central rod 1303 and is thus moveable along the central rod 1303, or the spring force exerted between the depth marker and/or limiter 1320 is reduced sufficiently to allow the depth marker and/or limiter 1320 to be slid along the central rod 1303 by a user.

FIG. 15 shows a side view of the depth marker and/or limiter 1320. FIG. 15 also shows the second user engagement arm 1415, second central rod engagement loop 1425, second engagement arm pivot location 1435, and crosspiece 1450. FIG. 15 also shows a loop interior width 1550 and a second central rod engagement loop angular displacement region 1555.

As discussed above, the depth marker and/or limiter 1320 may be used to identify a preset distance on the central rod 1303 by aligning the depth marker and/or limiter 1320 to a depth marking 1310 located along the central rod 1303. Actuating the engagement arms 1410, 1415 causes the engagement loops 1420, 1425 to change their angle relative to the central rod 1303. Furthermore, the engagement loops 1420, 1425 may function as springs when the force applied at the engagement arms 1410, 1415 twist the loops to change their angle relative to the central rod 1303. When the angle of the engagement loops 1420, 1425 changes, the second central rod engagement loop angular displacement region 1555 of the engagement loops 1420, 1425 spreads apart or increases, and the loop interior width 1550 perpendicular to the central rod 1303 increases. As the loop interior width 1550 is increased, friction between the depth marker and/or limiter 1320 and the central rod 1303 is decreased. This will allow the sliding motion of the depth marker and/or limiter 1320 along the central rod 1303.

When pressure is not applied at the engagement arms 1410, 1415, the loop interior width 1550 decreases and the engagement loops 1420, 1425 of the depth marker and/or limiter 1320 will apply pressure to and cause friction with the central rod 1303. This will prevent a sliding motion of the depth marker and/or limiter 1320 along the central rod 1303. Therefore, the depth marker is easy for the user to quickly move and set to a new position, and there is enough friction to prevent the depth marker from unintentional movement along the length of central rod 1303.

Another feature of the depth marker and/or limiter 1320 is the convenience for manufacturing. Being made from a sufficiently flexible material, such as stainless steel, spring steel, or rubber, the marker will be able to be installed along the length of the central rod 1303. Since the handle end 301 and the salt engagement fork end 302, obstruct the ends of the central rod 303, the depth marker and/or limiter 1320 will be prevented from sliding off the central rod 303. Once the depth marker and/or limiter 1320 is installed over the central rod 1303, the depth marker and/or limiter 1320 rest in its free state where it will grip the central rod 1303.

The material of the depth marker 1320 is not connected to the central rod 1303 at the first and second engagement arm pivot locations 1430, 1435, but the depth marker 1320 contacts the central rod 1303 and is induced into contact with the central rod 1303 through the spring force generated by the depth marker 1320. Contact of the first and second engagement arm pivot locations 1430, 1435 with the crosspiece 1450 may act as a fulcrum to allow the first and second central rod engagement loops 1420, 1425 to change angle relative to the central rod 1303. Because the depth marker 1320 is not connected to the central rod, the loop interior width 1550 may be increased which may allow the depth marker 1320 to move along the central rod 1303. The depth marker 1320 is composed of a sufficiently flexible and resilient material (such as steel) which allows the loop interior width 1550, first and second user engagement arms 1410, 1415, and first and second central rod engagement loops 1420, 1425 to be bent and then spring back to their original shape and position as shown in FIG. 14 after the depth marker 1320 has been repositioned along the central rod 1303 and the user disengages from the first and second user engagement arms 1410, 1415.

Additionally, although the discussion above provides the example of the tool 303 being used to break up a salt bridge, the tool 303 may also be employed to break up a salt mush. In operation, the tool may be inserted into the salt mush near the openings in the brine well 125 that are being obscured by the salt mush. The tool may then be rotated to break up the salt mush as described above with regard to a salt bridge.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A tool for use with a water softener brine tank, said tool including:
a handle end having a handle;
a salt engagement fork end including:
a central prong having a central prong tip; and
a salt engagement prong having a salt engagement prong tip; and
a central rod connecting said handle end to said salt engagement fork end, wherein said salt engagement prong is attached to said central rod at a prong attachment junction,
wherein said salt engagement prong is oriented at an acute angle to said central rod,
wherein said salt engagement prong is oriented helically around said central rod.

2. The tool of claim 1 wherein said central prong tip is further away from said handle than said salt engagement prong tip.

3. The tool of claim 1 wherein said salt engagement prong includes a maximal axial extent away from said central rod and wherein said salt engagement prong is curved so that said salt engagement prong tip curves away from said maximal axial extent and toward said central rod.

4. The tool of claim 1 wherein said salt engagement prong tip of said salt engagement prong is oriented to be further away from said handle relative to said prong attachment junction.

5. The tool of claim 1 wherein said salt engagement prong tip of said salt engagement prong is oriented to be closer to said handle relative to said prong attachment junction.

6. The tool of claim 1 wherein said handle includes first handle arm and a second handle arm, wherein said first handle arm and said second handle arm are oriented at an acute angle relative to said central rod.

7. The tool of claim 1 wherein said handle includes a handle top oriented substantially perpendicular to said central rod.

8. The tool of claim 6 wherein at least one of said first handle arm and said second handle arm includes a handle end cap.

9. The tool of claim 6 wherein at least one of said first handle arm and said second handle arm includes a widened grip structure.

10. The tool of claim 6 wherein at least one of said first handle arm and said second handle arm includes a plurality of grip protrusions.

11. A method for breaking up a salt bridge in a brine tank for a water softener, said method including:
inducing a salt bridge breaking tool into contact with a salt bridge, wherein said salt bridge breaking tool includes:
a handle end having a handle;
a salt engagement fork end including:
a central prong having a central prong tip; and
a salt engagement prong having a salt engagement prong tip; and
a central rod connecting said handle end to said salt engagement fork end, wherein said salt engagement prong is attached to said central rod at a prong attachment junction,
wherein said salt engagement prong is oriented at an acute angle to said central rod,
wherein said salt engagement prong is oriented helically around said central rod; and
rotating said handle to induce rotation of said salt engagement prong relative to said central prong to engage said salt engagement prong with said salt bridge and mechanically break said salt bridge.

12. The method of claim 11 wherein said handle includes first handle arm and a second handle arm, wherein said first handle arm and said second handle are rotated around said central rod to rotate said handle.

13. The method of claim 12 wherein said first handle arm and said second handle arm are oriented at an acute angle relative to said central rod.

14. The method of claim 11 wherein said central prong tip is further away from said handle than said salt engagement prong tip.

15. The method of claim 11 wherein said salt engagement prong includes a maximal axial extent away from said central rod and wherein said salt engagement prong is curved so that said salt engagement prong tip curves away from said maximal axial extent and toward said central rod.

16. The method of claim 11 wherein said salt engagement prong tip of said salt engagement prong is oriented to be further away from said handle relative to said prong attachment junction.

17. The method of claim 11 wherein said salt engagement prong tip of said salt engagement prong is oriented to be closer to said handle relative to said prong attachment junction.

18. The method of claim 12 wherein at least one of said first handle arm and said second handle arm includes a handle end cap.

19. The method of claim 12 wherein at least one of said first handle arm and said second handle arm includes a widened grip structure.

20. The method of claim 12 wherein at least one of said first handle arm and said second handle arm includes a plurality of grip protrusions.
